(19) United States
(12) Patent Application Publication
(10) Pub. No.: US 2006/0188422 A1
(43) Pub. Date: Aug. 24, 2006

(54) Device for purifying motor vehicle exhaust gases

(75) Inventors: Hanspeter Mayer, Adnet (AT); Dominikus Klawatsch, Weisen (AT)

Correspondence Address: GREENBLUM & BERNSTEIN, P.L.C., 1950 ROLAND CLARKE PLACE, RESTON, VA, 20191, US

(73) Assignee: PANKL EMISSION CONTROL SYSTEMS, Kapfenberg (AT)

(21) Appl. No.: 11/344,230

(22) Filed: Feb. 1, 2006

(30) Foreign Application Priority Data
Feb. 2, 2005 (AT) A 168/2005

(51) Int. Cl. B01D 53/34

(52) U.S. Cl. 423/212; 422/168

(57) ABSTRACT

Device and method for purifying motor vehicle exhaust gases. The device includes a metallic housing with plural intakes for a time-offset introduction of individual exhaust gas flows and at least one outlet for discharging exhaust gas. At least one purification module with at least one of: at least one filter element and at least one catalyst element is arranged within the housing, and a gas-permeable metal foam body is disposed on an intake side of the at least one purification module on an intake side. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of Austrian Patent Application No. A 168/2005, filed on Feb. 2, 2005, the disclosure of which is expressly incorporated by reference herein in its entirety.

### BACKGROUND OF THE INVENTION

1. Field of the Invention

The invention relates to a device for purifying motor vehicle exhaust gases. More particularly, the device includes a housing, several intakes, an outlet, and at least one purification module arranged within the housing.

2. Discussion of Background Information

Motor vehicle exhaust gases that are emitted unpurified or little purified from automobiles and commercial vehicles are considered to be one of the main causes of environmental pollution. Attempts are being made in many nations and regions to combat this adverse pollution load on the environment. Attempts usually take the form of statutory measures, for example, imposing maximum permissible pollutant levels for exhaust gases from motor vehicles.

Since the maximum pollutant levels for exhaust gases are regularly further lowered with new statutory measures or standards, there is a constant requirement on the part of automobile manufacturers to purify exhaust gases from motor vehicles better or more effectively. Efforts have hitherto concentrated mainly on improving the efficiency of purification modules for motor vehicle exhaust gases, which modules contain, e.g., coated catalyst elements for converting nitrogen oxides and/or filter elements such as diesel particulate filters.

In addition, in order to achieve the most effective possible purification of exhaust gases, there has also been a change towards making the best possible use of the entire space available in the exhaust train for purification modules. The aim is therefore to utilize not only a rear muffler to accommodate purification modules, but also a front part of the exhaust train connected to the engine. Exhaust gas produced by the operation of an engine is typically directly fed into exhaust trains at a temperature between approx. 500 and 800° C. via individual intakes. A larger amount of space is available for purification modules if purification modules are used at such points. However, whenever there are several intakes via which exhaust gas streams are fed, an undesirable load on the purification module(s) can occur. This is because a locally concentrated and time-offset intermittent feed of exhaust gas can lead to pressure peaks at the purification modules. Such pressure peaks can damage the modules, particularly at high exhaust gas temperatures and high thermal load.

### SUMMARY OF THE INVENTION

Against this background, the invention relates to a device for purifying motor vehicle exhaust gases in which a load on the purification module(s) by introduced exhaust gas streams is reduced. More particularly, the invention relates to a device comprising a housing, several intakes, an outlet, and at least one purification module arranged within the housing, wherein a load on the purification module(s) by introduced exhaust gas streams is reduced.

According to the invention, there is provided a device for purifying motor vehicle exhaust gases comprising: a metallic housing with plural intakes for a time-offset introduction of individual exhaust gas flows and at least one outlet for discharging exhaust gas; at least one purification module with at least one filter element and/or at least one catalyst element arranged within the housing such that introduced exhaust gas flows flow through the purification module to the outlet; and a gas-permeable metal foam body disposed upstream of the at least one purification module on an intake side.

Splitting an individual targeted and intensive exhaust gas flow into many diffuse partial flows of lower intensity takes place through a gas-permeable metal foam body on the basis of its labyrinthine or irregularly branched pore structure. As a result, the exhaust gas reaches the downstream purification modules diffused and with a lower intensity, and high pressure peaks at the modules can be avoided. The metal foam body, through its good thermal conduction, provides for distribution of the heat absorbed by the exhaust gas and avoidance of local overheating in the device. This is important not only with respect to a low thermal load on the metal foam body itself, but also on the purification modules, since they can contain ceramic elements or coatings which have only a low thermal loadability or have a low thermal shock resistance.

In a preferred embodiment of the invention, the metal foam body has a pore size of 5 to 20 ppi (pores per inch). A good distribution or division of exhaust gas flows fed in a time-offset manner can be achieved in this pore size range. If the pore size is less than 5 ppi, a division of the exhaust gas flows is rougher than in the preferred range. Also if the pore size is less than 5 ppi, pores have an average size at which the structural stability of the metal foam can suffer at high temperatures. At a pore size of more than 20 ppi, the metal foam body begins to act as a filter for particles, which is undesirable.

With respect to a high structural stability under varying thermal load, the metal foam body is advantageously made of an iron-based alloy. An iron-based alloy has proven to be particularly suitable which contains (in % by weight): 15 to 30% chromium, 5 to 10% vanadium, up to 2% aluminum, up to 2% yttrium, up to 2% cerium, up to 2% silicon, with the balance being iron and contaminants due to production. This alloy has a good corrosion-resistance, particularly when in contact with motor vehicle exhaust gases.

In an embodiment of the invention, the metal foam body is metallically directly connected to the metallic housing or is in contact with the housing via a metallic connecting piece. This produces an efficient heat dissipation from the metal foam body to the housing, whereby heat can then be dissipated from the surface of the housing. This allows the metal foam body to stay at a lower temperature and exhaust gas flowing in can thus be effectively cooled, which results in a gentle treatment of the downstream catalyst and/or filter elements.

The front sides of the purification modules are spaced apart from the metal foam body. This renders the purification modules freely accessible and provides a uniform flow to the front sides of purification modules.

According to the invention, several purification modules are provided, which are detachably held in a holder connected to the housing. This makes it possible to easily replace individual purification modules in the event they are no longer operational.

A device according to the invention has proven particularly effective where exhaust gas is fed at an angle of 90°, where the housing is essentially cylindrically with intakes laterally arranged and an outlet arranged on the front (i.e., longitudinally)

The metal foam body can be of any geometrical shape, and is preferably in the form of a plate or a broad flat piece. This offers little resistance to exhaust gas flows and combats a pressure build-up and thus reduced engine performance. It is particularly advantageous if the plate extends essentially over an entire width and/or length of the housing when seen in cross-section, because the exhaust gas flows can then be dispersed over a correspondingly large area with slight back pressure.

The plate can be detachably connected to the housing if it is to be quickly replaceable or removable.

Further advantages and effects of the invention are shown by the context of the specification and the exemplary embodiments.

The present invention is directed to a device for purifying motor vehicle exhaust gases. The device includes a metallic housing with plural intakes for a time-offset introduction of individual exhaust gas flows and at least one outlet for discharging exhaust gas. At least one purification module with at least one of: at least one filter element and at least one catalyst element is arranged within the housing, and a gas-permeable metal foam body is disposed on an intake side of the at least one purification module on an intake side.

According to a feature of the invention, the metal foam body can have a pore size of 5 to 20 ppi.

In accordance with another feature of the present invention, the metal foam body can include an iron-based alloy. The iron-based alloy can contain (in % by weight): 15 to 30% chromium, 5 to 10% vanadium, up to 2% aluminum, up to 2% yttrium, up to 2% cerium, and up to 2% silicon. The balance can be iron and contaminants due to production.

According to the instant invention, the metal foam body can be metallically directly connected to the housing.

The metal foam body may be arranged spaced apart from the at least one purification module.

Further, the at least one purification module can include a plurality of purification modules detachably held in a holder connected to the housing.

According to a further feature of the invention, the housing may be essentially cylindrical with the intakes can be arranged laterally and the at least one outlet arranged longitudinally.

The metal foam body can include a plate. The plate may extend essentially over at least one of an entire width and length of the housing. Further, the plate may be detachably connected to the housing.

The introduced exhaust gas flows can flow through the at least one purification module to the at least one outlet.

Further, a flow path may extend from the intakes, through the metal foam body, through the at least one purification module, to the at least one outlet.

The present invention is directed to a method of purifying motor vehicle exhaust gases. The method includes introducing exhaust gas into a housing through plural intakes, directing the exhaust gas through a metal foam body, directing the exhaust gas through at least one purification module, and directing the exhaust gas through an outlet.

In accordance with a feature of the method, the housing may be essentially cylindrical with the intakes arranged laterally and the outlet arranged longitudinally.

According to another feature of the method, the metal foam body may be an iron-based alloy that contains (in % by weight): 15 to 30% chromium, 5 to 10% vanadium, up to 2% aluminum, up to 2% yttrium, up to 2% cerium, and up to 2% silicon. The balance may be iron and contaminants due to production.

According to still another feature of the method, the at least one purification module may include a plurality of purification modules detachably held in a holder connected to the housing.

Further, the method can include metallically connecting the metal foam body to the housing, and dissipating heat from the exhaust gas through the metal foam body and the housing.

In accordance with still yet another feature of the present invention, the method can further include splitting an individual targeted and intensive exhaust gas flow into a plurality of diffuse partial flows of lower intensity

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1a A cross-section along a longitudinal axis of a device with a cylindrical housing and several purification modules;

FIG. 1b: A cross-section perpendicular to the longitudinal axis of a device with a cylindrical housing and several purification modules;

FIG. 2a: A cross-section along a longitudinal axis of a device with a cylindrical housing and a purification module; and

FIG. 2b: A cross-section perpendicular to the longitudinal axis of a device with a cylindrical housing and a purification module.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

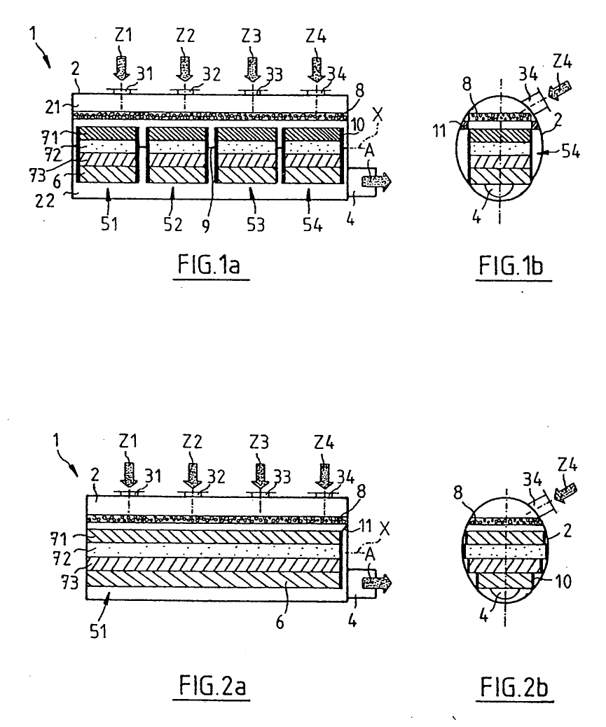

FIG. 1a shows a cross section along a longitudinal axis X of a device 1 for purifying exhaust gases of commercial vehicles with a cylindrical housing 2 and several purification modules 51, 52, 53, 54. The cylindrical housing 2 comprises an upper housing part 21 and a lower housing part 22 that are connected to one another and can be opened or separated as needed. Intakes 31, 32, 33, 34, through which exhaust gas flows Z1, Z2, Z3, Z4 can be introduced, and an outlet 4 for discharged exhaust gas A are formed on the housing 2. Apart from the intakes 31, 32, 33, 34 and the outlet 4, the housing is gas-tight. According to FIG. 1a, introduced exhaust gas flows Z1, Z2, Z3, Z4 therefore reach outlet 4 approximately at a right angle.

A metal foam body 8 is located inside the housing 2 on the intake side. Downstream from the metal foam body 8 there are several purification modules 51, 52, 53, 54, which respectively feature a filter element 6 and catalyst elements 71, 72, 73 and which are respectively held in a holder 9. The individual purification modules 51, 52, 53, 54 can be respectively connected to the holder 9 in a detachable manner, so that if one of the purification modules 51, 52, 53, 54 breaks down or becomes inoperable, only this one needs to be replaced, while the other modules can be left unchanged. The purification modules 51, 52, 53, 54 are respectively surrounded by a gas-tight jacket 10, which ensures that the exhaust gas for purification flows through the purification modules 51, 52, 53, 54 over their entire length and cannot escape laterally unpurified or partially purified.

The metal foam body 8 extends approximately over an entire length of the housing 2 and, as FIG. 1b shows, over a width of the same. If exhaust gas flows Z1, Z2, Z3, Z4 are now introduced intermittently or in a pulsing manner via the corresponding intakes 31, 32, 33, 34, they strike a surface of the metal foam plate 8 on the intake side at an angle and are divided into individual partial flows. These individual partial flows ultimately emerge at a surface of the metal foam body 8 facing the purification modules 51, 52, 53, 54 and flow uniformly to the fronts of downstream purification modules 51, 52, 53, 54.

The metal foam body 8 is installed in the housing 2 such that introduced exhaust gas flows Z1, Z2, Z3, Z4 strike it at an angle of approximately 25°. The installation can be made by direct metallic connection such as soldering or welding, so that a good dissipation of the heat of the exhaust gas absorbed by the metal foam body 8 to the housing is rendered possible. Alternatively, a metallic frame 11 for holding the metal foam body 8 or a like connecting piece can also be inserted between housing 2 and metal foam body 8, provided that a metallic contact from the metal foam body 8 to the housing 2 and thus an effective heat dissipation is given.

An angle between an exhaust gas flow Z1, Z2, Z3, Z4 and the plate-shaped metal foam body is approximately 25° as shown in FIG. 1b. A better separation of the individual exhaust gas flows is thus achieved than with a perpendicular flow to the metal foam body 8. In practice, approach angles of 15° to 65° have proven effective. Unexpectedly, it was also found that noise emission is also reduced with such an arrangement. Therefore, the metal foam body 8 thus also has a sound-absorbing effect.

Downstream of the metal foam body 8, purification modules 51, 52, 53, 54 are arranged detachably in a holder 9. Each module front or input surface is parallel to and spaced apart from the plate-shaped metal foam body 8. This provides a uniform distribution of the exhaust gas to be purified via the various purification modules 51, 52, 53, 54. If a permanently unequal loading of the purification modules 51, 52, 53, 54 nevertheless occurs and a single one becomes inoperative, it can be removed from the holder 9 and replaced with a new one.

FIGS. 2a and 2b show an alternative embodiment of a device 1 that differs from the embodiment according to FIG. 1a and 1b in that instead of several purification modules only a single purification module 51 is provided. Similar to the modules shown in FIG. 1a and FIG. 1b, the purification module 51 is made up of several catalyst elements 71, 72, 73 connected to one another and a filter element 6. In contrast to the modules shown in FIG. 1a and FIG. 1b, the respective catalyst elements 71, 72, 73 and the filter element 6 extend essentially over the entire length of the housing 2 and are adjusted in their respective width to a maximum available free housing diameter. A seal element 11 ensures that all the exhaust gas flows through the purification module 51. The adjustment of catalyst and filter elements leads to an improved utilization of the housing interior for purification modules and consequently to an improved exhaust gas purification.

The production of a metal foam body 8 provided according to the invention can take place according to any production routes known to one skilled in the art. In connection with the invention, it has proven particularly effective to produce the metal foam body in that first a porous polyurethane foam is produced by foaming pellets, which foam is filled with metal powder via a suspension; subsequently the polyurethane foam that determines the pore structure is burnt out through heating and the remaining metal foam is sintered while maintaining its open-pored structure. With such a method, structurally stable metal foam bodies can be produced close to their final dimensions so that they can be inserted in a device for purifying motor vehicle exhaust gases without further measures.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A device for purifying motor vehicle exhaust gases, comprising:
a metallic housing with plural intakes for a time-offset introduction of individual exhaust gas flows and at least one outlet for discharging exhaust gas;
at least one purification module with at least one of: at least one filter element and at least one catalyst element arranged within the housing; and
a gas-permeable metal foam body disposed on an intake side of the at least one purification module on an intake side.

2. The device according to claim 1, wherein the metal foam body has a pore size of 5 to 20 ppi.

3. The device according to claim 1, wherein the metal foam body comprises an iron-based alloy.

4. The device according to claim 3, wherein the iron-based alloy contains (in % by weight):
15 to 30% chromium,
5 to 10% vanadium,
up to 2% aluminum,
up to 2% yttrium,
up to 2% cerium, and
up to 2% silicon,
wherein the balance is iron and contaminants due to production.

5. The device according to claim 1, wherein the metal foam body is metallically directly connected to the housing.

6. The device according to claim 1, wherein the metal foam body is arranged spaced apart from the at least one purification module.

7. The device according to claim 1, wherein the at least one purification module comprises a plurality of purification modules detachably held in a holder connected to the housing.

8. The device according to claim 1, wherein the housing is essentially cylindrical with the intakes are arranged laterally and the at least one outlet arranged longitudinally.

9. The device according to claim 1, wherein the metal foam body comprises a plate.

10. The device according to claim 9, wherein the plate extends essentially over at least one of an entire width and length of the housing.

11. The device according to claim 9, wherein the plate is detachably connected to the housing.

12. The device according to claim 1, wherein the introduced exhaust gas flows flow through the at least one purification module to the at least one outlet.

13. The device according to claim 1, further comprising a flow path extending from the intakes, through the metal foam body, through the at least one purification module, to the at least one outlet.

14. A method of purifying motor vehicle exhaust gases, comprising:
introducing exhaust gas into a housing through plural intakes;
directing the exhaust gas through a metal foam body;
directing the exhaust gas through at least one purification module; and
directing the exhaust gas through an outlet.

15. The method of claim 14, wherein the housing is essentially cylindrical with the intakes arranged laterally and the outlet arranged longitudinally.

16. The method of claim 14, wherein the metal foam body comprises an iron-based alloy that contains (in % by weight):
15 to 30% chromium,
5 to 10% vanadium,
up to 2% aluminum,
up to 2% yttrium,
up to 2% cerium, and
up to 2% silicon,
wherein the balance is iron and contaminants due to production.

17. The method of claim 14, wherein the at least one purification module comprises a plurality of purification modules detachably held in a holder connected to the housing.

18. The method of claim 14, further comprising:
metallically connecting the metal foam body to the housing; and
dissipating heat from the exhaust gas through the metal foam body and the housing.

19. The method of claim 14, further comprising splitting an individual targeted and intensive exhaust gas flow into a plurality of diffuse partial flows of lower intensity.
